(19) United States
(12) Patent Application Publication
(10) Pub. No.: US 2024/0095791 A1
(43) Pub. Date: Mar. 21, 2024

(54) A METHOD FOR AUTONOMOUS RECONCILIATION OF INVOICE DATA AND RELATED ELECTRONIC DEVICE

(71) Applicant: MAERSK A/S, Copenhagen K (DK)

(72) Inventors: Abhishek SANWALIYA, Bangalore (IN); Sunil Kumar CHINNAMGARI, Bangalore (IN); Aadil Ahmad MALIK, Anantnag (IN); Mrittunjoy DAS, Asansol (IN)

(21) Appl. No.: 18/262,077

(22) PCT Filed: Jan. 28, 2022
(86) PCT No.: PCT/EP2022/052046

§ 371 Date: Jul. 19, 2023

(30) Foreign Application Priority Data
Jan. 29, 2021 (DK) PA 2021 70043

(51) Int. Cl. G06Q 30/04; G06F 40/279; G06F 40/30

(52) U.S. Cl. CPC G06Q 30/04; G06F 40/279; G06F 40/30

(57) ABSTRACT

Disclosed is a method, performed by an electronic device, for autonomous reconciliation of invoice data. The method comprises obtaining an invoice data set. The method comprises determining, based on the invoice data set and an entity extraction model, an entity extraction set comprising an entity parameter and a first value parameter. The first value parameter is associated with a first confidence score parameter. The method comprises outputting, based on the entity extraction set, an information extraction result for reconciliation of invoice data.

The present disclosure pertains to the field of transport and freight. The present disclosure relates to a method for autonomous reconciliation of invoice data and related electronic device.

### BACKGROUND

Invoice reconciliation is necessary for customers to get their invoices processed timely, to avoid forthcoming disputes and to sort out the differences well in time. Any kind of delay in confirming the match or mismatch from an invoice can have negative impact on customer service with delay in settlement and clearance. Invoice reconciliation also takes resources, such as manual intervention. A manual intervention introduces delay in payment posting and confirming invoice details which consequently results in an increased resolution time to process the invoice and to reconcile the invoice specifics. Invoice reconciliation is particularly vulnerable to human subjectivity in processing invoices. Invoice reconciliation also needs specialization and speed. This is also particularly vulnerable to human subjectivity.

### SUMMARY

The time consumed in invoice reconciliation is significant, and may lead to an inconsistent handling, and to an incorrect result of the reconciliation. Invoice reconciliation requests are repetitive, however resolving them requires going through the complex set of rules with numerous validations, thereby leading an increased the likelihood of human errors and inconsistencies.

There is a need for supporting the technical processing of data which forms part of the process of invoice reconciliation. There is a need for a tool which supports the process of invoice reconciliation and reduces the time consumed on such processing while improving consistency and reducing subjectivity.

There is a need for an electronic device and a method that may address these shortcomings and provide a more robust and efficient processing for invoice reconciliation.

Accordingly, there is a need for an electronic device and a method for autonomous reconciliation of invoice data, which mitigate, alleviate or address the shortcomings existing and a more time efficient control of the processing for invoice reconciliation with improved accuracy and consistency.

Disclosed is a method, performed by an electronic device, for autonomous reconciliation of invoice data. The method comprises obtaining an invoice data set. The method comprises determining, based on the invoice data set and an entity extraction model, an entity extraction set comprising an entity parameter and first value parameter. The first value parameter is associated with a first confidence score parameter. The method comprises outputting, based on the entity extraction set, an information extraction result for reconciliation of invoice data.

Further, an electronic device is provided. The electronic device comprises a memory circuitry, a processor circuitry, and a wireless interface. The electronic device is configured to perform any of the methods according to the disclosure.

Also disclosed is a computer readable storage medium storing one or more programs. The one or more programs comprise instructions, which when executed by an electronic device cause the electronic device to perform any of the methods disclosed herein.

It is an advantage of the present disclosure that the disclosed electronic device and method provide a more time efficient control of the processing for invoice reconciliation with improved accuracy and consistency. Advantageously, the disclosed electronic device and method provide high accuracy and wide extendibility for various scenarios, and invoice formats. The disclosed technique is efficient and can be replicated across various verticals and/or operations globally for un-structured text e.g. available in PDF, image, excel and/or email object format. The architecture disclosed herein supports scalability to multiple concurrent requests for real-time implementations.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically example invoice data according to this disclosure,

FIG. 2 is a diagram illustrating schematically a process where the disclosed technique is carried out by an example electronic device according to this disclosure,

FIG. 3 is a diagram illustrating schematically an example representation of information extraction according to this disclosure,

FIG. 4 is a flow-chart illustrating an exemplary method, performed by an electronic device, for reconciliation of invoice data according to this disclosure, and

FIG. 5 is a block diagram illustrating an exemplary electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

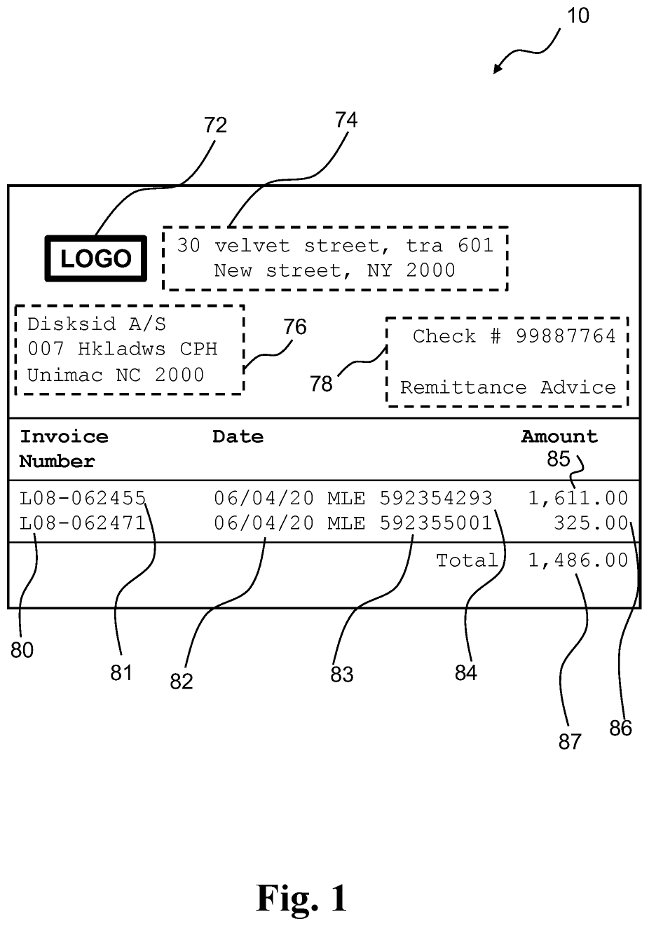

FIG. 1 is a diagram illustrating schematically example invoice data 10 according to this disclosure.

The invoice data 10 is represented as an invoice with a logo 72, a first address parameter 74 indicative of a first address, a second address parameter 76 indicative of a second address, a check parameter 78 indicative of Payment index and/or cheque number, a first invoice number 80, a second invoice number 81, two dates 82, a first bill of lading parameter 83 indicative of a first bill of lading, a second bill of lading parameter 84 indicative of a second bill of lading, a first amount parameter 85 indicative of a first amount, a second amount parameter 86 indicative of a second amount, and a total amount parameter 87 indicative of the total amount.

Invoice data 10 is seen as unstructured data available in invoice. There exist multiple formats (such as PDF text, image, excel sheet, text file, voice data, image data, and/or email object).

It may be appreciated that for an electronic device, it is difficult to identify which address parameter 74, 76 corresponds the address of the issuer of the invoice represented in 10. The same applies for invoice date, and the invoiced item(s), the total amount, the subtotal amounts etc.

The disclosed technique takes unstructured data from diversified invoice formats and progressively applies a machine-learning model to extract information based on patterns learnt by an entity extraction model. The entity extraction model disclosed herein may extract entity parameter(s) and a corresponding value parameter, which can then be sent for payment posting and reconciliation. The entity parameters that may be extracted from invoice data 10 may comprises a logo, a first address, a second address, a payment index, a cheque number, an invoice number, a bill of lading, an amount, and/or a total amount. Other entity parameters can be used as well, depending on the situation.

As the invoice data 10 comes as unstructured data, the disclosed technique may apply one or more: cleansing, normalizing and transforming to the invoice data 10 to feed into the entity extraction model (such as information extraction model). The disclosed technique may perform pattern identification based on training instances to provide robust and best-in-class accuracy model.

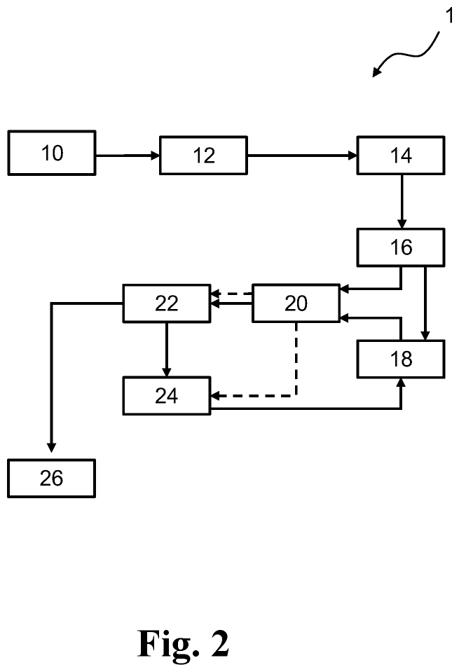

FIG. 2 is a diagram illustrating a process 1 where the disclosed technique is carried out by an example electronic device according to this disclosure.

Invoice data 10 may be seen as un-structured data. Invoice data 10 may be fed into a step 12 of the disclosed technique related to an information extraction technique (such as image augmentation, text pre-processing, and/or noise reduction). For example, the step 12 may provide an invoice data set which may be cleansed and/or standardized to a pattern identification step 14. The step 14 provides filtered invoice data set to a standardisation step 16 for standardizing and/or normalizing the invoice data set.

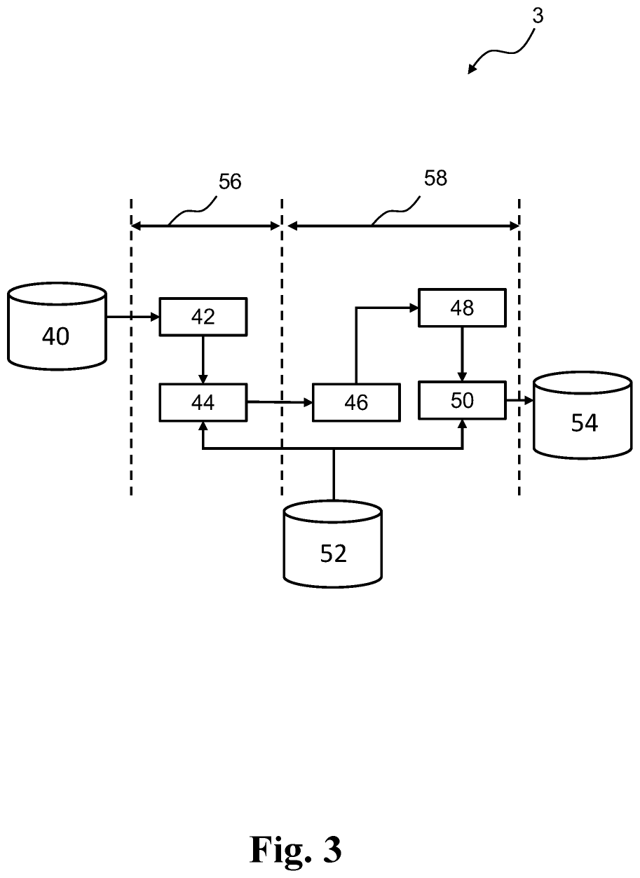

Step 16 provides standardized invoice data set to an entity extraction model 20 (illustrated in FIG. 3) to determine an entity extraction set comprising an entity parameter and first value parameter and an associated first confidence score. The entity extraction model 20 may receive a feedback input from a master pattern update 18 to improve the entity extraction model 20.

The entity extraction model 20 determines, based on the invoice data set, an entity extraction set comprising an entity parameter and first value parameter, wherein the first value parameter is associated with a first confidence score parameter.

The entity extraction model 20 may provide the entity extraction set to a classifier step 22 that output, as extraction result 26, an entity parameter and a first value parameter of the extraction set where the first confidence score satisfies a criterion, such as a high confidence score. The classifier step 22 may provide the extraction result 26 for reconciliation of invoice data.

Alternatively, the entity extraction model 20 may provide to the classifier step 22, the extraction result 26 comprising an entity parameter and a first value parameter of the extraction set where the first confidence score satisfies a criterion, such as a high confidence score and may include in a fine-tuning data set 24 an entity parameter and a second value parameter of the extraction set where the second confidence score does not satisfy the criterion, such as a low confidence score. The fine-tuning data set 24 may be passed on to the master pattern update 18 for fine tuning the entity extraction model.

The disclosed technique may be seen as an automated reconciliation of invoice data e.g. for booking invoices. For example, the disclosed technique may be seen as a machine learning enabled information extraction required for payment postings and reconciliation.

The disclosed technique eliminates manual intervention for extracting invoice details required to confirm payment postings and concerns raised by customers due to mismatch in invoice particulars. The disclosed technique may optionally allow manual intervention if needed for complex issues.

The disclosed technique may use natural language processing, NLP, and/or computer vision based information extraction to obtain relevant invoice details which can be streamlined to downstream applications to complete the posting and reconciliation. A NLP based information extraction model provides intelligence with zero subjectivity to identify invoice particulars which can be processed in fraction of time compared to manual route. The disclosed technique may eventually free-up resources dealing with thousands of invoices and improve the processing which is also error prone and contains lot of subjectivity.

The disclosed technique may be seen as aiming at resolving invoice mismatches against shipment booking. The disclosed technique may eventually automate the process and reduce human effort to validate booking invoices.

FIG. 3 is a diagram illustrating schematically an example representation 3 of information or entity extraction model according to this disclosure.

In one or more example methods, the entity extraction model comprises a Natural Language Processing model. In one or more example methods, the entity extraction model comprises one or more of: a text classification, an identification of one or more candidate text segments, and a context feature extraction, as illustrated in FIG. 3. In one or more example methods, the entity extraction model can be a combination of models, classifiers, and/or methods, etc.

For example, unstructured text along with labeled information may be provided as input from input documents database 40. For example, the input after further image augmentation, data processing/standardization may be supplied to the document feature extraction 42 (such as feature extraction model). Further text classification 44 may be performed which performs identification of candidate text segments 46. This may be seen as text filtering 56.

Context feature extraction 48 may be performed using text segments 46 and classification model 50 to select the relevant information. The relevant information may be stored in a database 54. The example process illustrated may be repeated over training instances given by a training data 52 and retains considerable patterns based on associative strength. This may be seen as information extraction phase 58. The extracted and/or learnt pattern may be utilized for extracting information from future and/or test instances.

The extracted information given in the information extraction result disclosed herein may be provided as an API to be used by a downstream application to trigger invoice postings and complete reconciliation in automated manner.

Invoice data may come from different vendors and/or customers and the disclosed technique performs training to learn patterns associated with information required for payment posting.

In some scenarios, the disclosed technique can achieve 80-90% accurate information extraction. In some scenarios, the disclosed technique can achieve 80-95% accurate information extraction. In some scenarios, the disclosed technique can achieve 80-100% accurate information extraction. In some scenarios, the disclosed technique can achieve 80, 85, 90, 95, or 100% accurate information extraction.

The disclosed technique allows for automatically identifying the correct details that are needed to update for invoice confirmation and clearance. The disclosed technique allows invoice posting confirmation requests to be processed within fraction of seconds. The disclosed technique allows invoice clearance to be processed faster and accurately, as there is no manual intervention. The disclosed technique allows human efforts to read the free text and process the invoice to be eliminated.

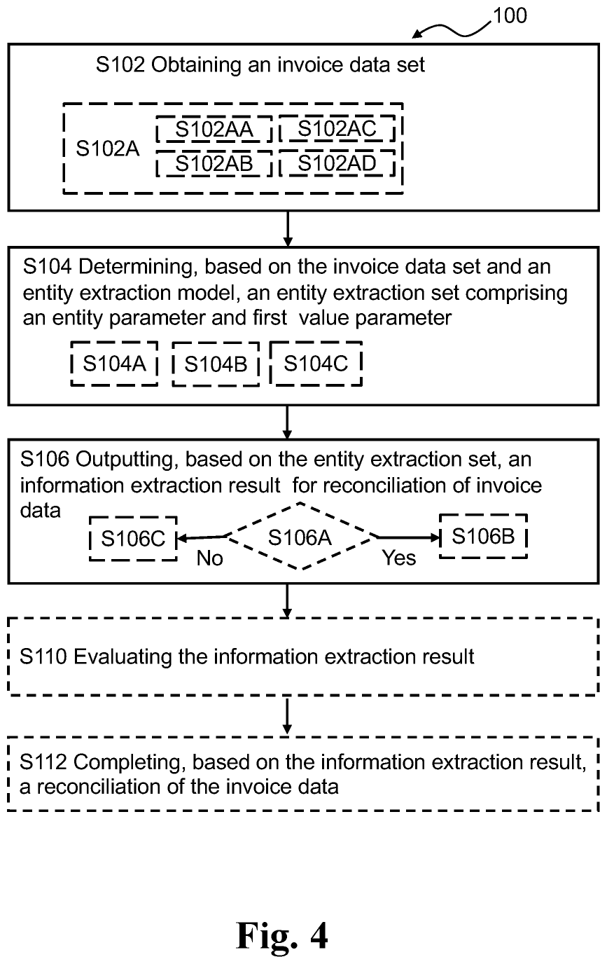

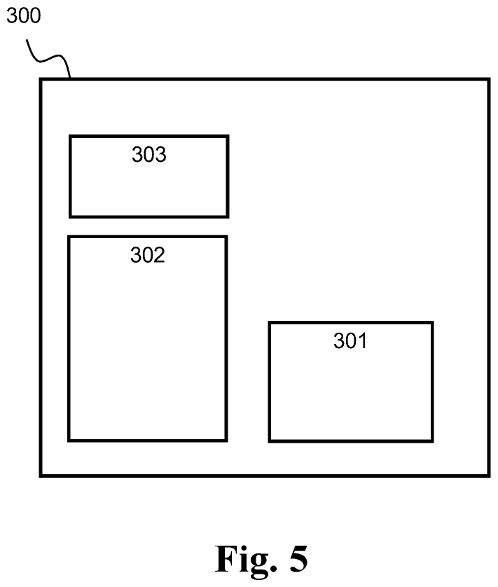

FIG. 4 is a flow chart illustrating an example method 100, performed by an electronic device (such as the electronic device disclosed herein, such as electronic device 300 of FIG. 5), for autonomous reconciliation of invoice data according to the disclosure.

The method 100 comprises obtaining S102 an invoice data set. The invoice data set may be indicative of invoice data, such as data from one or more invoices. In one or more example methods, the invoice data comprises un-structured data, such as un-structured text. In one or more example methods, the obtaining S102 comprises obtaining S102A, based on the invoice data, the invoice data set.

In one or more example methods, the obtaining S102A comprises extracting S102AA the invoice data set from the invoice data using an information extraction technique. In one or more example methods, the information extraction technique comprises one or more of: a computer vision technique, an image augmentation technique and a text processing technique.

In one or more example methods, the obtaining S102A comprises reducing S102AB noise in the invoice data set. The noise in the invoice data set may refer to corruption in the invoice data set, such as additional meaningless and/or incorrect data elements. In one or more example methods, reducing S102AB the noise in the invoice data set may comprise removing features identified as noisy in the invoice data set. In one or more example methods, reducing S102AB the noise in the invoice data set may comprise lowering down the importance of particular feature(s). In other words, the noise in the invoice data set may be seen as cancelled, removed and/or suppressed.

In one or more example methods, the obtaining S102A comprises standardising S102AC the invoice data set. For example, standardising S102AC the invoice data set may comprise information standardisation, such as YYMMDD to follow a date format, and/or currency standardisation, such as USD amount format vs EUR amount format. Standardization may comprise normalizing a data set. Normalizing a data set may refer to restricting the data set so that attributes of data elements of the data set that are standardized to comply with one or more of the same representation “norms” or types. A normalization may be performed using scaling, and/or encoding.

In one or more example methods, the obtaining S102A comprises obtaining S102AD the invoice data set based on an identification of one or more invoice data patterns indicative of mandatory information for invoice processing in the invoice data set. In one or more example methods, the one or more invoice data patterns indicative of mandatory information for invoice processing may comprise one or more invoice data patterns indicative of information necessary to process a corresponding invoice. In other words, the one or more invoice data patterns indicative of mandatory information for invoice processing may comprise invoicing details which may be necessary to process a corresponding invoice. For example, an outcome of an identification of one or more invoice data patterns may comprise identifying multiple dates in the invoice data set (such as in text), but identifying an invoice date to be the most important. For example, an outcome of an identification of one or more invoice data patterns may comprise filtering out relevant information (such as mandatory information).

The method 100 comprises determining S104, based on the invoice data set and an entity extraction model, an entity extraction set comprising an entity parameter and a first value parameter. In one or more example methods, the first value parameter is associated with a first confidence score parameter. An entity parameter may be seen as a parameter indicative of an entity, such as an entity in an entity extraction technique. For example, an entity parameter may comprise a parameter indicative of one or more of: an invoice issuer name, an invoice issuer address, an invoice recipient name, an invoice recipient address, an item invoiced, a quantity for each items, an amount for an item invoiced, a subtotal amount, a total amount, a VAT number, a VAT amount, a date for settlement, an invoicing data, and any other parameters configured to appear on an invoice (e.g. illustrated in FIG. 1). A confidence score parameter, disclosed herein, (such as the first confidence score parameter) may be seen as a parameter that provide the confidence score given to a value parameter, such as how confident the entity extraction model is the value parameter determined for entity parameter.

For example, the entity extraction model determines, based on the invoice data, the entity extraction set comprising the entity parameter and a first value parameter, and optionally a second value parameter and optionally a third value parameter, wherein the first value parameter is associated with the first score parameter, and optionally the second value is associated with a second score parameter, and optionally the third value is associated with a third score parameter.

For example, when the entity parameter is indicative of an invoice date, this may be given by the entity extraction model, based on the invoice data set, the following value parameters: a first value parameter 20210107 with a first score parameter 0.9, and optionally a second value 20201207 with a score parameter 0.2, because the entity extraction model is capable of identifying, using e.g. invoice data patterns and/or context feature extraction, that the date 20211207 is the purchase date and not the invoice date.

The entity extraction set may comprise a first entity parameter and a first value parameter, a second entity parameter and a second value parameter, a third entity parameter and a third value parameter, each associated with respective score parameters. Each entity parameter may be indicative of a invoice data element, such as an invoice date parameter, a bill of lading parameter, an address parameter, an invoice number, a subtotal amount parameter, and a total amount parameter.

In one or more example methods, the entity extraction model is configured to extract an entity parameter indicative of invoice information from an invoice data set based on unstructured invoice data (such as invoice data 10 of FIGS. 1-2).

In one or more example methods, the entity extraction model comprises a Natural Language Processing model. In one or more example methods, the entity extraction model comprises one or more of: a text classification, an identification of one or more candidate text segments, and a context feature extraction, as illustrated in FIG. 3.

In one or more example methods, the determining S104 comprises applying S104A the text classification to the invoice data set. In one or more example methods, the determining S104 comprises identifying S104B, based on the text classification, the one or more candidate text segments. In one or more example methods, the determining S104 comprises extracting S104C a context feature parameter based on the one or more candidate text segments.

The method 100 comprises outputting S106, based on the entity extraction set, an information extraction result for reconciliation of invoice data. In one or more example methods, the result is sent to a system for handling invoices. For example, the result may be sent to the system for handling invoices, for reconciliation of invoice data, such that an invoice may be processed and settled. The information extraction result allows comparing or matching invoice data (such as invoice details) against customer booking information. The information extraction may send a trigger to a downstream application to conclude reconciliation. For confirmed reconciliation cases based on the information extraction result, invoice submission and clearance can proceed to conclude payment posting. The system is capable to take ‘unstructured text’ data from invoice, which further intelligently identifies particulars and feed further to complete reconciliation and payment clearance.

In one or more example methods, the outputting S106 comprises determining S106A whether the first confidence score parameter satisfies a criterion. In one or more example methods, the outputting S106 comprises, when it is determined that the first confidence score parameter satisfies the criterion, including S106B the entity parameter and the first value parameter into the information extraction result. In one or more example methods, the criterion is based on a threshold, such as a confidence threshold, such as 0.9, such as 0.7. For example, the that the first confidence score parameter satisfies the criterion, when the that the first confidence score parameter is above the threshold.

In one or more example methods, the outputting S106 comprises determining S106A whether the first confidence score parameter satisfies a criterion. In one or more example methods, the outputting S106 comprises, when it is determined that the first confidence score parameter does not satisfy the criterion, including S106C the entity parameter associated with the first value parameter into a fine-tuning data set. In other words, the outputting S106 comprises, when it is determined that the first confidence score parameter does not satisfy the criterion, including S106C the entity parameter associated with the first value parameter into the fine-tuning data set (as illustrated as 24 in FIG. 2), but not into the information extraction result. In some examples, the outputting S106 can output a request for an agent to review any data associated with the low confidence score parameter.

In one or more example methods, the fine-tuning data set is taken as an input by the entity extraction model and/or is taken to update the one or more invoice data patterns. In or more example methods, the fine tuning data set is taken as input for training the entity extraction model.

In one or more example methods, the method 100 comprises evaluating S110 the information extraction result based on one or more patterns from historical invoice data (such as in terms of relation complexity of historical invoice data). The information extraction result may be evaluated further against relation complexity with pattern evaluation (historical vendor invoices). For example, the information extraction result may be compared, evaluated or matched against the entity patterns coming from historical invoices. Based on relationship of pattern with particular type of entity, further tuning may be performed if extracted pattern is not having similarity as compare to historical patterns/entity values.

In one or more example methods, the method 100 comprises completing S112, based on the information extraction result, a reconciliation of the invoice data. The extracted information given in the information extraction result disclosed herein may be provided as an API to be used by a downstream application to trigger invoice postings and complete reconciliation in automated manner.

FIG. 5 shows a block diagram of an exemplary electronic device 300 according to the disclosure. The electronic device 300 can be, for example, a computer, laptop, tablet, cellular phone, and/or combinations thereof. The electronic device 300 comprises memory circuitry 301, processor circuitry 302, and an interface 303. The electronic device 300 is configured to perform any of the methods disclosed in FIG. 4. In other words, the electronic device 300 is configured for autonomous reconciliation of invoice data.

The interface 303 may configured for wired and/or wireless communications e.g. with an invoice payment system.

The electronic device is configured to obtain (such as via the interface 303, and/or the memory circuitry 301) an invoice data set. The electronic device is configured to determine (e.g. via the processor circuitry 302), based on the invoice data set and an entity extraction model, an entity extraction set comprising an entity parameter and first value parameter. The first value parameter is associated with a first confidence score parameter.

The electronic device is configured to output (e.g. using the processor circuitry 302, and/or the interface 303), based on the entity extraction set, an information extraction result for reconciliation of invoice data.

The processor circuitry 302 is optionally configured to perform any of the operations disclosed in FIG. 2 (such as any one or more of: S102A, S102AA, S102AB, S102AC, S102AD, S104A, S104B, S104C, S106A, S106B, S106C, S110, S112). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302.

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store one or more programs, the one or more programs comprising instructions in a part of the memory.

The memory circuitry 301 may be configured to store information such as information related to invoice data set, entity extraction model, entity extraction set, entity parameter, value parameter (such as first value parameter), confidence score parameter (such as first confidence score parameter), information extraction result and/or invoice data in a part of the memory.

Embodiments of methods and products (electronic device) according to the disclosure are set out in the following items:
Item 1. A method, performed by an electronic device, for autonomous reconciliation of invoice data, the method comprising:
   obtaining (S102) an invoice data set;
   determining (S104), based on the invoice data set and an entity extraction model, an entity extraction set comprising an entity parameter and a first value parameter, wherein the first value parameter is associated with a first confidence score parameter; and
   outputting (S106), based on the entity extraction set, an information extraction result for reconciliation of invoice data.
Item 2. The method according to item 1, wherein the obtaining (S102) comprises obtaining (S102A), based on the invoice data, the invoice data set.
Item 3. The method according to any of the previous items, wherein the obtaining (S102A) comprises extracting (S102AA) the invoice data set from the invoice data using an information extraction technique.
Item 4. The method according to item 3, wherein the information extraction technique comprises one or more of: a computer vision technique, an image augmentation technique, a Natural Language Processing technique, and a text processing technique.
Item 5. The method according to any of items 2-4, wherein the obtaining (S102A) comprises reducing (S102AB) noise in the invoice data set.
Item 6. The method according to any of items 2-5, wherein the obtaining (S102A) comprises standardising (S102AC) the invoice data set.
Item 7. The method according to any of items 2-6, wherein the obtaining (S102A) comprises obtaining (S102AD) the invoice data set based on an identification of one or more invoice data patterns indicative of mandatory information for invoice processing in the invoice data set.
Item 8. The method according to any of items 2-7, wherein the invoice data comprises un-structured data.
Item 9. The method according to any of the previous items, wherein the entity extraction model comprises a Natural Language Processing model.
Item 10. The method according to any of the previous items, wherein the entity extraction model comprises one or more of: a text classification, an identification of one or more candidate text segments, and a context feature extraction.
Item 11. The method according to item 10, wherein the determining (S104) comprises applying (S104A) the text classification to the invoice data set.
Item 12. The method according to any one of items 10-11, wherein the determining (S104) comprises identifying (S104B), based on the text classification, the one or more candidate text segments.
Item 13. The method according to any of items 10-12, wherein the determining (S104) comprises extracting (S104C) a context feature parameter based on the one or more candidate text segments.
Item 14. The method according to any of the previous items, wherein the outputting (S106) comprises:
   determining (S106A) whether the first confidence score parameter satisfies a criterion; and
   when it is determined that the first confidence score parameter satisfies the criterion, including (S106B) the entity parameter and the first value parameter into the information extraction result.
Item 15. The method according to any of items 1-13, wherein the outputting (S106) comprises:
   determining (S106A) whether the first confidence score parameter satisfies a criterion; and
   when it is determined that the first confidence score parameter does not satisfy the criterion, including (S106C) the entity parameter associated with the first value parameter into a fine-tuning data set.
Item 16. The method according to item 15 as dependent on item 7, wherein the fine tuning data set is taken as an input by the entity extraction model and/or is taken to update the one or more invoice data patterns.
Item 17. The method according to any of items 14-16, wherein the criterion is based on a threshold.
Item 18. The method according to any of the previous items, the method comprising evaluating (S110) the information extraction result based on one or more patterns from historical invoice data.
Item 19. The method according to any of the previous items, the method comprising completing (S112), based on the information extraction result, a reconciliation of the invoice data.
Item 20. An electronic device comprising memory circuitry, processor circuitry, and a wireless interface, wherein the electronic device is configured to perform any of the methods according to any of items 1-19.
Item 21. A computer readable storage medium storing one or more programs, the one or more programs comprising instructions, which when executed by an electronic device cause the electronic device to perform any of the methods of items 1-19.

The use of the terms “first”, “second”, “third” and “fourth”, “primary”, “secondary”, “tertiary” etc. does not imply any particular order, but are included to identify individual elements.

Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-5 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by an electronic device, for autonomous reconciliation of invoice data, the method comprising:
obtaining an invoice data set;
determining, based on the invoice data set and an entity extraction model, an entity extraction set comprising an entity parameter and a first value parameter, wherein the first value parameter is associated with a first confidence score parameter; and
outputting, based on the entity extraction set, an information extraction result for reconciliation of invoice data.

2. The method according to claim 1, wherein the obtaining comprises obtaining, based on the invoice data, the invoice data set.

3. The method according to claim 1, wherein the obtaining comprises extracting the invoice data set from the invoice data using an information extraction technique.

4. The method according to claim 3, wherein the information extraction technique comprises one or more of: a computer vision technique, an image augmentation technique, a Natural Language Processing technique, and a text processing technique.

5. The method according to claim 2, wherein the obtaining comprises reducing noise in the invoice data set.

6. The method according to claim 2, wherein the obtaining comprises standardising the invoice data set.

7. The method according to claim 2, wherein the obtaining comprises obtaining the invoice data set based on an identification of one or more invoice data patterns indicative of mandatory information for invoice processing in the invoice data set.

8. The method according to claim 2, wherein the invoice data comprises un-structured data.

9. The method according to claim 1, wherein the entity extraction model comprises a Natural Language Processing model.

10. The method according to claim 1, wherein the entity extraction model comprises one or more of: a text classification, an identification of one or more candidate text segments, and a context feature extraction.

11. The method according to claim 10, wherein the determining comprises applying the text classification to the invoice data set.

12. The method according to claim 10, wherein the determining comprises identifying, based on the text classification, the one or more candidate text segments.

13. The method according to claim 10, wherein the determining comprises extracting a context feature parameter based on the one or more candidate text segments.

14. The method according to claim 1, wherein the outputting comprises:
determining whether the first confidence score parameter satisfies a criterion; and
when it is determined that the first confidence score parameter satisfies the criterion, including the entity parameter and the first value parameter into the information extraction result.

15. The method according to claim 1, wherein the outputting comprises:
determining whether the first confidence score parameter satisfies a criterion; and
when it is determined that the first confidence score parameter does not satisfy the criterion, including the entity parameter associated with the first value parameter into a fine-tuning data set.

16. The method according to claim 15, wherein the fine-tuning data set is taken as an input by the entity extraction model and/or is taken to update the one or more invoice data patterns.

17. The method according to claim 14, wherein the criterion is based on a threshold.

18. The method according to claim 1, the method comprising evaluating the information extraction result based on one or more patterns from historical invoice data.

19. The method according to claim 1, the method comprising completing, based on the information extraction result, a reconciliation of the invoice data.

20. An electronic device comprising memory circuitry, processor circuitry, and a wireless interface, wherein the electronic device is configured to perform any of the methods according to claim 1.

21. (canceled)
